(19) United States
(12) Patent Application Publication
(10) Pub. No.: US 2009/0191526 A1
(43) Pub. Date: Jul. 30, 2009

(54) BEHAVIOR IMPROVEMENT SUPPORT APPARATUS AND BEHAVIOR IMPROVEMENT SUPPORT METHOD

(75) Inventors: Toshimitsu Kumazawa, Kawasaki-shi (JP); Koji Kimura, Kawasaki-shi (JP); Akinori Hongu, Fujisawa-shi (JP); Hideki Kobayashi, Yokohama-shi (JP)

Correspondence Address: OHLANDT, GREELEY, RUGGIERO & PERLE, LLP, ONE LANDMARK SQUARE, 10TH FLOOR, STAMFORD, CT, 06901, US

(73) Assignee: KABUSHIKI KAISHA TOSHIBA

(21) Appl. No.: 12/357,786

(22) Filed: Jan. 22, 2009

(30) Foreign Application Priority Data
Jan. 29, 2008 (JP) 2008-018036

(51) Int. Cl. G09B 19/00

(52) U.S. Cl. 434/236; 434/238

(57) ABSTRACT

A behavior improvement support apparatus for presenting information to prompt reduction of environmental load imposed by a user's living space, stores in a memory, in regard to a plurality of parameters each having a plurality of values for specifying presentation methods of the information, one of the values of each parameter, presents the information during a given period of time, based on the one of the values of each parameter stores in the memory, measures the amount of emission of the environmental load imposed by the living space during the period of time, evaluates, based on the amount of emission of the environmental load during the period of time, an effect of the one of the values of each parameter used when the information is presented, and updates, based on an evaluation result, the one of the values of at least one of the parameters stored in the memory.

### CROSS-REFERENCE TO RELATED APPLICATIONS

This application is based upon and claims the benefit of priority from prior Japanese Patent Application No. 2008-018036, filed Jan. 29, 2008, the entire contents of which are incorporated herein by reference.

### BACKGROUND OF THE INVENTION

1. Field of the Invention

The present invention relates to a behavior improvement support apparatus for appropriately presenting information to prompt environmental load reduction.

2. Description of the Related Art

According to a survey made by the Japan Consumer Information Center, more than 90% of Japanese people are interested in saving energy. However, energy consumption in the consumer section is still growing, and it is therefore pointed out that there is a gap between the rising awareness of ecological problems and people's actual behavior.

Two measures are available for energy saving in homes: improvement of the performance of houses and energy-using products (EuPs), and control of energy consumption. Energy consumption control is classified into automatic control by hardware and indirect control by information presentation.

In automatic control by hardware, an energy-using product (EuP) is controlled based on information from a sensor (e.g., temperature sensor or pyroelectric sensor) to prevent wasteful operations, thereby saving energy.

In indirect control by information presentation, the target value or record value of energy consumption is presented in comparison with those of other persons or in the form of ranking. This raises an occupant's awareness of energy saving and evokes his/her behavior, thereby saving energy (e.g., JP-A 2001-101292 (KOKAI), and JP-A 2001-344412 (KOKAI)).

In the conventional indirect control method by information presentation, specific data such as energy consumption is presented in a specific form, thereby raising the occupant's awareness of energy saving and evoking his/her behavior. This method is assumed to give the same information to any occupant. The open references have suggested that this method enables to reduce energy consumption by 5% to 20%.

As the problems of these conventional methods, the effect largely varies between persons even when they receive the same information, and energy saving cannot be achieved at all in some cases. Additionally, the effect gradually weakens because of habituations to information presentation.

### BRIEF SUMMARY OF THE INVENTION

According to embodiments of the present invention, there is provided a behavior improvement support apparatus for presenting information to prompt reduction of environmental load imposed by a user's living space, which includes:

a parameter memory to store, in regard to a plurality of parameters each having a plurality of values for specifying presentation methods of the information, one of the values of each parameter;

an information presentation unit configured to present the information during a given period of time, based on the one of the values of each parameter stores in the parameter memory;

a measurement unit configured to measure the amount of emission of the environmental load imposed by the living space during the period of time;

an evaluation unit configured to evaluate, based on the amount of emission of the environmental load during the period of time, an effect of the one of the values of each parameter used when the information is presented; and

a parameter updating unit configured to update, based on an evaluation result of the evaluation unit, the one of the values of at least one of the parameters stored in the parameter memory;

wherein the information presentation unit presents the information during the next period of time based on the value of each parameter which is stored in the parameter memory after update.

### BRIEF DESCRIPTION OF THE SEVERAL VIEWS OF THE DRAWING

FIG. 1 is a block diagram showing an example of the arrangement of a behavior improvement support apparatus according to an embodiment of the present invention;

FIG. 2 is a flowchart for explaining the processing operation of the behavior improvement support apparatus shown in FIG. 1;

FIG. 3 is a table showing an example of data stored in a parameter storage unit;

FIG. 4 is a table showing a detailed example of a plurality of values of each parameter predetermined for a display item “energy consumption”;

FIG. 5 is a table showing a detailed example of a plurality of values of each parameter predetermined for a display item “advice”;

FIG. 6 is a view showing an example of information presentation;

FIG. 7 is a view showing another example of information presentation;

FIG. 8 is a table showing an example of measured data stored in a measured data storage unit;

FIG. 9 is a table showing another example of measured data stored in the measured data storage unit;

FIG. 10 is a table showing an example of evaluation result data stored in an evaluation result storage unit;

FIG. 11 is a table for explaining a selection probability updating method;

FIG. 12 is a table showing combinations of the values of parameters of the display item “energy consumption”, and the evaluation results of the effect of information presentation during an information presentation period in which information presentation is done based on the combinations;

FIG. 13 is a table showing examples of conditions for an increase in energy consumption, which are obtained using the rough set theory for the information shown in FIG. 12; and

FIG. 14 is a table showing an example of a presentation window which presents values to be changed to a user.

### DETAILED DESCRIPTION OF THE INVENTION

An embodiment of the present invention will now be described with reference to the accompanying drawing.

### [Arrangement]

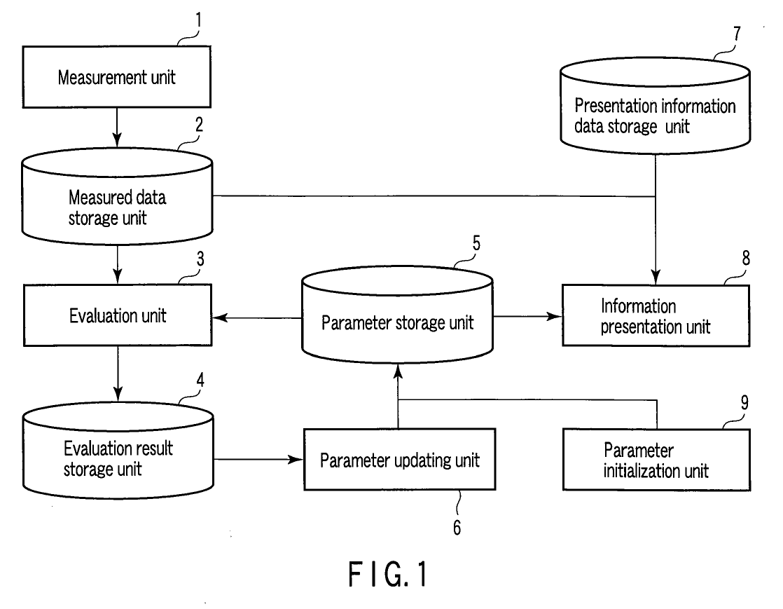

A behavior improvement support apparatus shown in FIG. 1 will be described here, which presents optimum information to a user (occupant) who occupies a living space such as a home or place of work, thereby prompting reduction of an environmental load caused by his/her lifestyle. An environmental load is a factor that is the result of human behavior and causes difficulties in protecting the global environment. Detailed examples of environmental loads are water use, energy consumption, gas use, and CO₂ output.

As shown in FIG. 1, the behavior improvement support apparatus includes a measurement unit 1 which measures a criterion such as energy consumption, a measured data storage unit 2 which stores data measured by the measurement unit 1, an evaluation unit 3 which evaluates an effect of information presentation based on measured data and an evaluation result, an evaluation result storage unit 4 which stores an evaluation result obtained by the evaluation unit 3, a parameter storage unit 5 which stores the items (display items) of information to be presented and information presentation parameters each having a plurality of levels (or values) necessary for specifying the information display method of each display item, a parameter updating unit 6 which updates the information presentation parameters based on the evaluation result stored in the evaluation result storage unit 4, a presentation information data storage unit 7 which stores information to be presented in advance, an information presentation unit 8 which presents the information stored in the presentation information data storage unit 7 on, e.g., a display in accordance with the parameters set in the parameter storage unit 5, and a parameter initialization unit 9 which initializes the information presentation parameters.

[Processing Procedure]

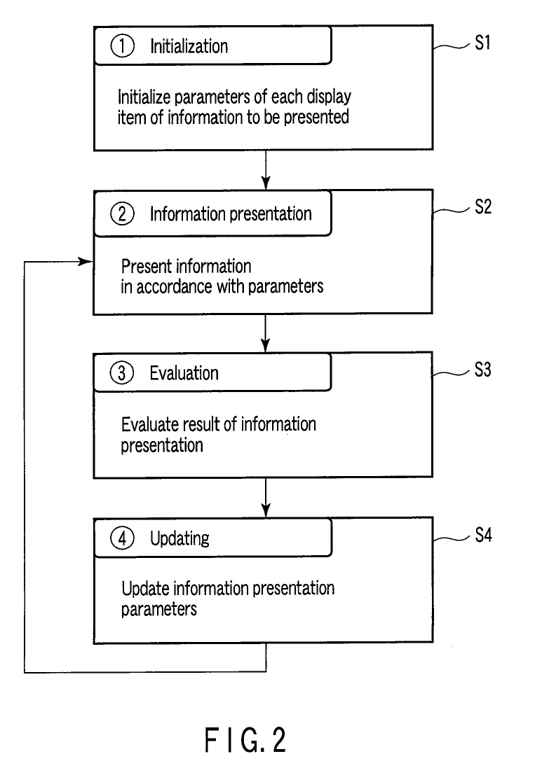

FIG. 2 shows the procedure of an effective information presentation method which prompts each occupant to adopt behavior significant for environmental load reduction. A detailed example will be described below with reference to the flowchart in FIG. 2.

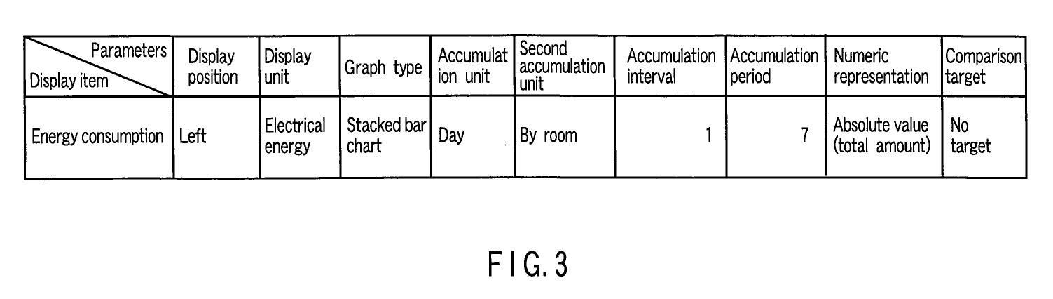

In step S1, the parameter initialization unit 9 sets the initial levels (values) of parameters which are predetermined for each display item of information to be presented to prompt behavior significant for environmental load reduction and are necessary for specifying the display method including the display position and the display unit. The set initial values of the parameters are stored in the parameter storage unit 5 using the format shown in FIG. 3.

The initial values of the parameters of each display item can be either determined as given values or set at random. When determining given values, if a combination of initial values having an effect on average is obtained by pre-surveys, these values are used preferably.

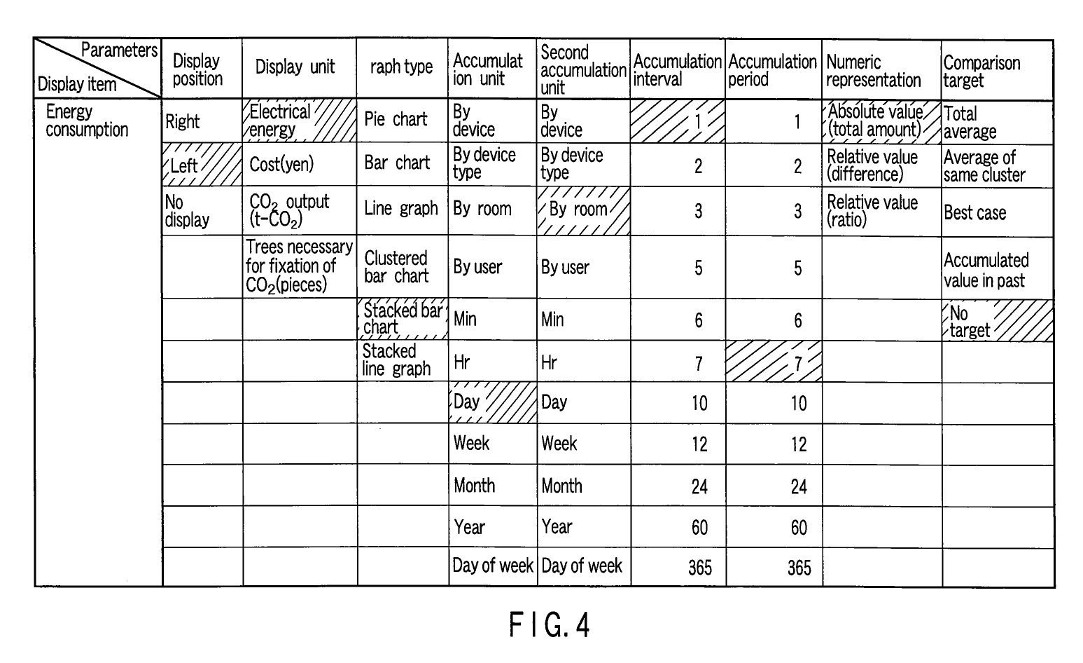

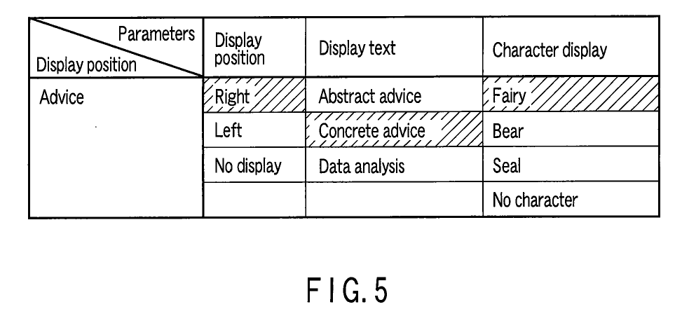

FIGS. 4 and 5 show examples of values (to also be referred to as levels or choices) settable for the parameters predetermined for display items “energy consumption” and “advice” out of pieces of information to be presented to prompt behavior significant for environmental load reduction.

FIG. 4 shows the levels (choices) of each parameter predetermined for the display item “energy consumption”. The parameters include “display position”, “display unit”, “graph type”, “accumulation unit”, “second accumulation unit”, “accumulation interval”, “accumulation period”, “numeric representation”, and “comparison target”.

“Display position” represents the display position of “energy consumption” in the overall display area of the display. In this embodiment, the display area is divided into two, left and right areas. The value of the parameter is selected from three levels (choices): “right”, “left”, and “no display”. Generally, the display area is divided into arbitrary areas, and labels assigned to the respective divided areas are set as choices.

“Display unit” represents how to express the amount of “energy consumption”. In this embodiment, there are four levels (choices): “electrical energy (kWh)”, “cost (yen)”, “CO₂ output (t-CO₂)”, and “trees necessary for fixation of CO₂ (pieces)”. The value of the parameter is selected from them. Energy consumption can be expressed directly as electrical energy. Alternatively, it can be converted into the cost, or represented by emission of CO₂ produced by the energy consumption, or the number of trees required for processing the CO₂ released into the atmosphere. Energy consumption may be expressed by the influence of CO₂ output (e.g., an increase in atmospheric temperature, a rise in sea level, the melted amount of ice of the South Pole, or the number of extinct species).

“Graph type” represents the type of a graph to be used to display “energy consumption”. In this embodiment, there are six levels (choices): “pie chart”, “bar chart”, “line graph”, “clustered bar chart”, “stacked bar chart”, and “stacked line graph”. The value of the parameter is selected from them.

“Accumulation unit” represents the type of the accumulation unit of the item on the abscissa of a graph. In this embodiment, there are 11 levels (choices): “by device”, “by device type”, “by room”, “by user”, “minute”, “hour”, “day”, “week”, “month”, “year”, and “day of week”. The value of the parameter is selected from them.

“Second accumulation unit” represents the type of the accumulation unit in a graph such as “clustered bar chart”, “stacked bar chart”, or “stacked line graph”, which can express a more specific accumulation unit for each item on the abscissa. In this embodiment, there are 11 levels (choices), like “accumulation unit”: “by device”, “by device type”, “by room”, “by user”, “minute”, “hour”, “day”, “week”, “month”, “year”, and “day of week”. The value of the parameter is selected from them.

“Accumulation interval” represents the time interval of accumulation for “accumulation unit” represented by a time unit such as “minute”, “hour”, “day”, “week”, “month”, “year”, or “day of week”. In this embodiment, the value of the parameter is selected from levels (choices) expressed by numerical values “1”, “2”, “3”, “5”, “7”, “10”, “12”, “24”, “60”, and “365”. These numerical values can thus be prepared as choices in advance, or integer values may be set.

“Accumulation period” represents the period for accumulating values to be displayed on a graph. In this embodiment, the value of the parameter is selected from levels (choices) expressed by numerical values “1”, “2”, “3”, “5”, “7”, “10”, “12”, “24”, “60”, and “365”. These numerical values can also be prepared as choices in advance, or integer values may be set, like the items of “accumulation interval”.

“Numeric representation” represents the numeric representation method of “energy consumption”. In this embodiment, the value of the parameter is selected from three levels (choices): “absolute value (total amount)”, “relative value (difference)”, and “relative value (ratio)”.

“Comparison target” represents the target to be displayed together with “energy consumption” and compared. In this embodiment, the value of the parameter is selected from five levels (choices): “total average”, “average of same cluster”, “best case”, “accumulated value in the past”, and “no target”.

FIG. 5 shows the choices of each parameter predetermined for the display item “advice”. The parameters include “display position”, “display text”, and “character display”.

“Display position” represents the display position of “advice” in the overall display area. In this embodiment, the display area of the display is divided into two, left and right areas. The value of the parameter is selected from three levels (choices): “right”, “left”, and “no display”.

“Display text” represents the degree of abstraction of advice to be displayed. The value of the parameter is selected from three levels (choices): “abstract advice”, “concrete advice”, and “data analysis”. In accordance with the degree of abstraction of the selected level, advice corresponding to the measurement result is selected from candidates prepared in advance for the degree of abstraction of each level.

“Character display” represents the type of a character which gives advice. In this embodiment, the value of the parameter is selected from “fairy”, “bear”, “seal”, “no character”.

The display items may include “water use”, “gas use”, and “device use log” in addition to “energy consumption” and “advice” described above. A combination of display items (e.g., air conditioner temperature setting and energy consumption) may be set. The parameters may include items associated with the display method, such as the display location, display count, and display timing. Not only information display using a GUI but also information presentation using sound, smell, vibration, or a combination thereof (e.g., robot) may be set.

The list of display items and levels (choices) settable as the values of the parameters predetermined for each display item as shown in FIGS. 4 and 5 may be stored in the parameter storage unit 5 in advance.

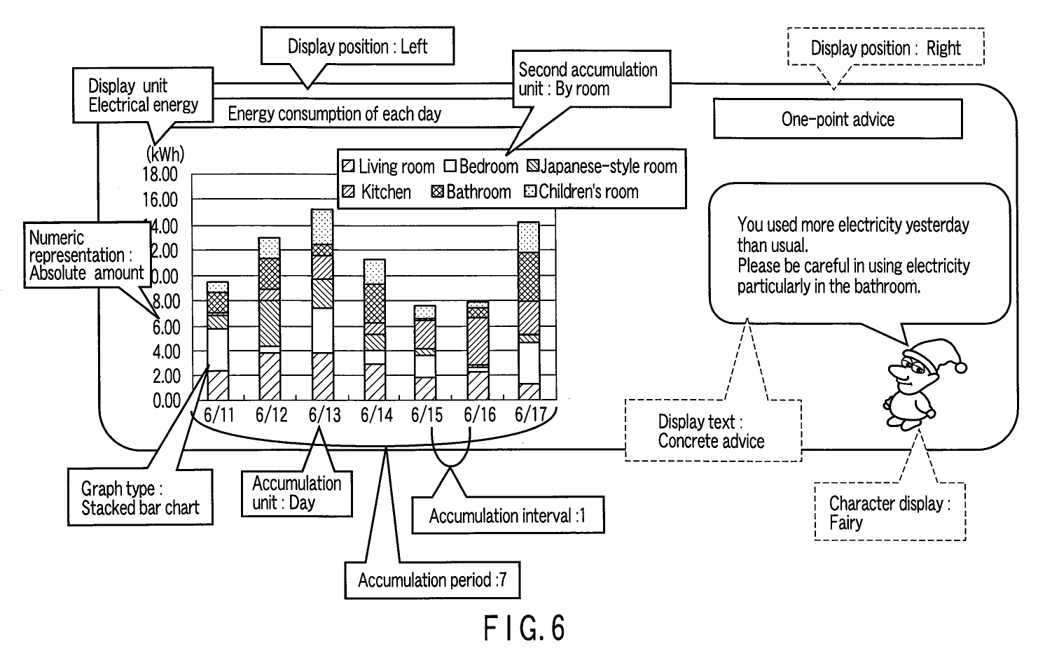

In step S2, the information presentation unit 8 presents information in accordance with the levels of parameters designated for each display item. Content data (e.g., advices and characters) necessary for information presentation are stored in the presentation information data storage unit 7 in advance. FIG. 6 shows an example of information presentation based on the levels of initial settings indicated by hatched cells in FIGS. 4 and 5.

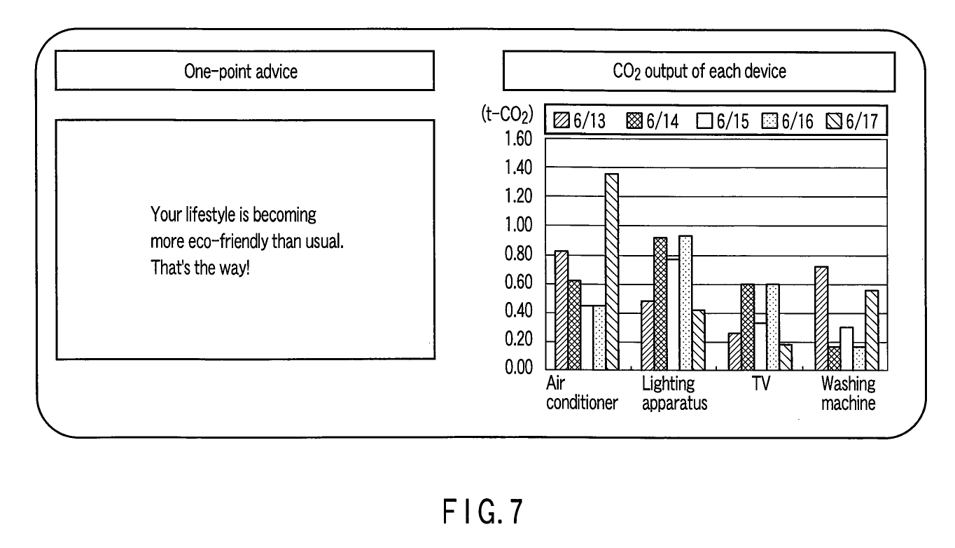

FIG. 7 shows another example of information presentation when the values of the parameters of the display item “energy consumption” shown in FIG. 4 and the values of the parameters of the display item “advice” shown in FIG. 5 are set in the following way.

Display item “energy consumption”
parameter “display position”: right
parameter “display unit”: CO₂ output (t-CO₂)
parameter “graph type”: clustered bar chart
parameter “accumulation unit”: by device type
parameter “second accumulation unit”: day
parameter “accumulation interval”: 1
parameter “accumulation period”: 5
parameter “numeric representation”: absolute value (total amount)
parameter “comparison target”: no target

Display item “advice”
parameter “display position”: left
parameter “display text”: abstract advice
parameter “character display”: no character

More specifically, the information presentation unit 8 can be a dedicated display terminal having a display. The information presentation unit 8 may be implemented by causing a computer to execute software to display information as shown in FIG. 6 or 7 on a display. The information presentation unit 8 may be designed to display information as shown in FIG. 6 or 7 using a display function prepared in a home TV.

The information presentation unit 8 presents information as shown in FIG. 6 or 7 for a predetermined period (information presentation period) designated in advance.

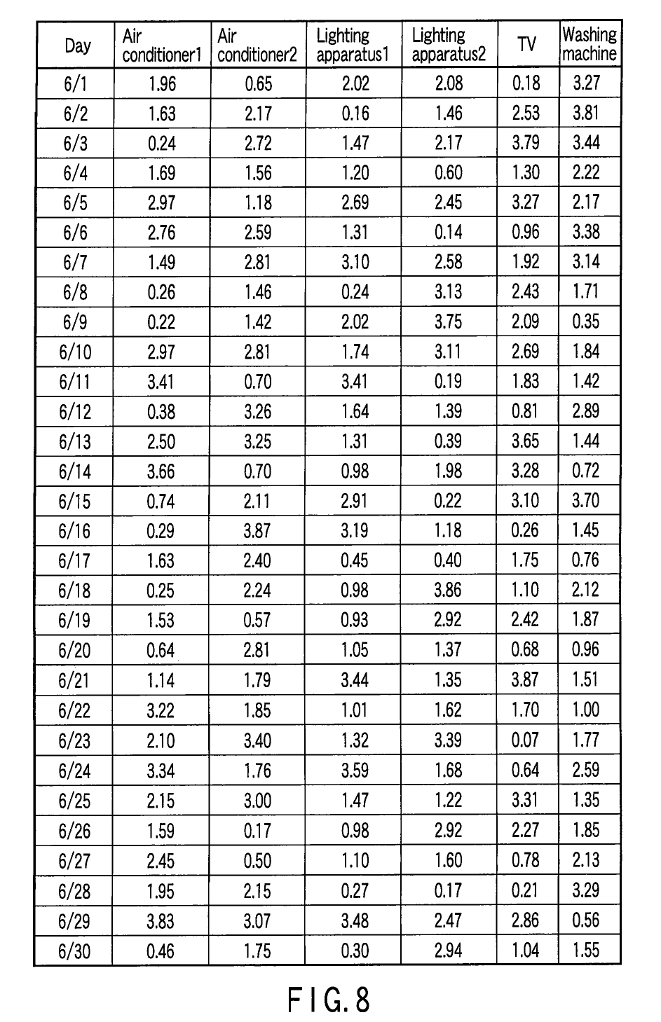

In step S3, during information presentation by the information presentation unit 8, the measurement unit 1 measures, e.g., the energy consumption of each device in a living space such as a home or place of work, and the measured data storage unit 2 stores the measurement result in a format shown in FIG. 8. The evaluation unit 3 evaluates the degree of improvement by information presentation based on the stored measured data of the energy consumption. For example, based on the measured data shown in FIG. 8, which are measured by the measurement unit 1 during the information presentation period when the information presentation unit 8 is presenting information, the evaluation unit 3 calculates, as an evaluation value, the total energy consumption during the information presentation period. The evaluation unit 3 evaluates the quality of the effect of the level of each parameter (i.e., information presentation) used during the information presentation period (or a level representing the effect of information presentation) based on the evaluation value.

For example, the information presentation period is set to “one week”, and information presentation during one week is evaluated based on the measured data shown in FIG. 8. The total energy consumption (evaluation value) during the week from 6/17 to 6/23 in which information presentation shown in FIG. 6 was done is assumed to be 71.5 kWh. The total energy consumption (evaluation value) during the week from 6/24 to 6/30 in which information presentation shown in FIG. 7 was done is assumed to be 76.8 kWh. The energy consumption increase during one week in which information presentation shown in FIG. 7 was done. Hence, the environmental load reduction effect of (the level of each parameter used in) the information presentation in FIG. 7 can be evaluated to be poorer than the effect of (the level of each parameter used in) the information presentation in FIG. 6.

The effect of the level of each parameter used in information presentation, i.e., the environmental load emission reduction effect by information presentation is evaluated here based on an increase/decrease in the energy consumption. Instead, water use or gas use, or a value obtained by converting the use into a CO₂ output based on CO₂ emission per kWh may be used. Not only evaluation based on an increase/decrease in the measured value but also evaluation based on user's personal viewpoint such as a browsing time, questionnaire, or evaluation input may be used.

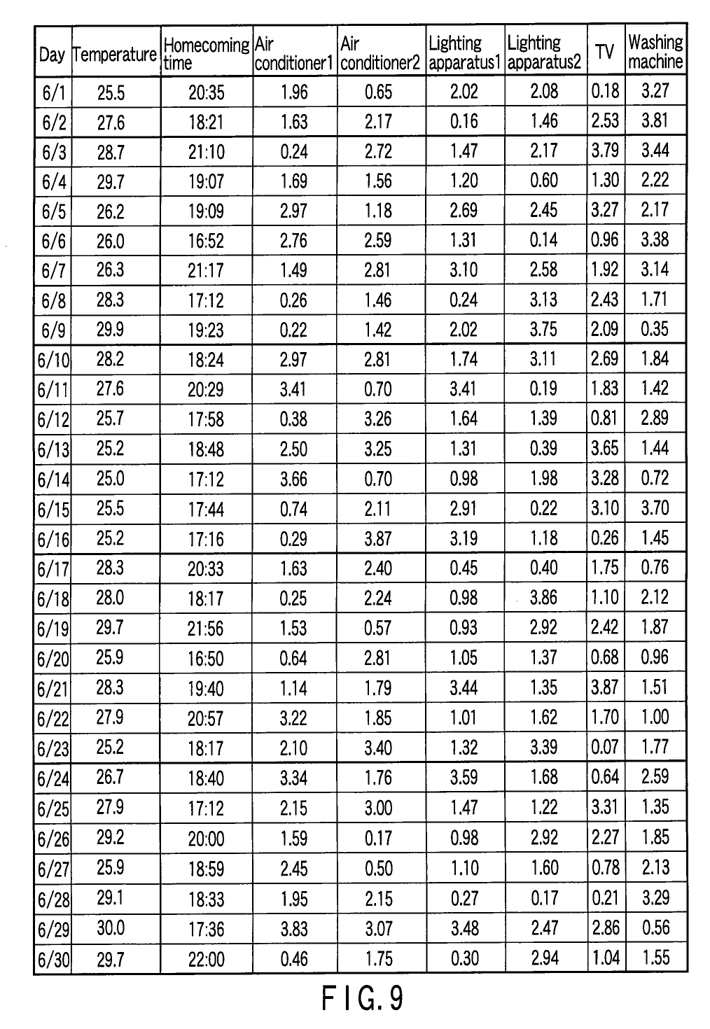

However, a measured value such as energy consumption largely changes depending on external factors such as temperature and humidity and factors of occupant's situations such as homecoming time and occupancy time. Hence, to evaluate the increase/decrease in the energy consumption as the information presentation effect, the conditions must be adjusted to some extent. To do this, the measured data storage unit 2 stores not only energy consumption as the evaluation target as shown in FIG. 8 but also items such as temperature and homecoming time which are associated with the conditions of the measurement day, as shown in FIG. 9.

In this case, the evaluation unit 3 calculates, as an evaluation value, the average value of energy consumptions of days except the days of the highest and lowest temperatures and the days of the earliest and latest homecoming times in the measurement result of the week from 6/17 to 6/23 and that of the week from 6/24 to 6/30 to be compared. The increase/decrease in the energy consumption is compared using this evaluation value. The obtained average value may be compared with the average value (evaluation value) of the same month a year ago. Alternatively, clustering of measured data in the past is performed based on measurement condition items such as temperature, humidity, and occupancy time, and comparison of the average value (evaluation value) of energy consumptions may be done in the same cluster.

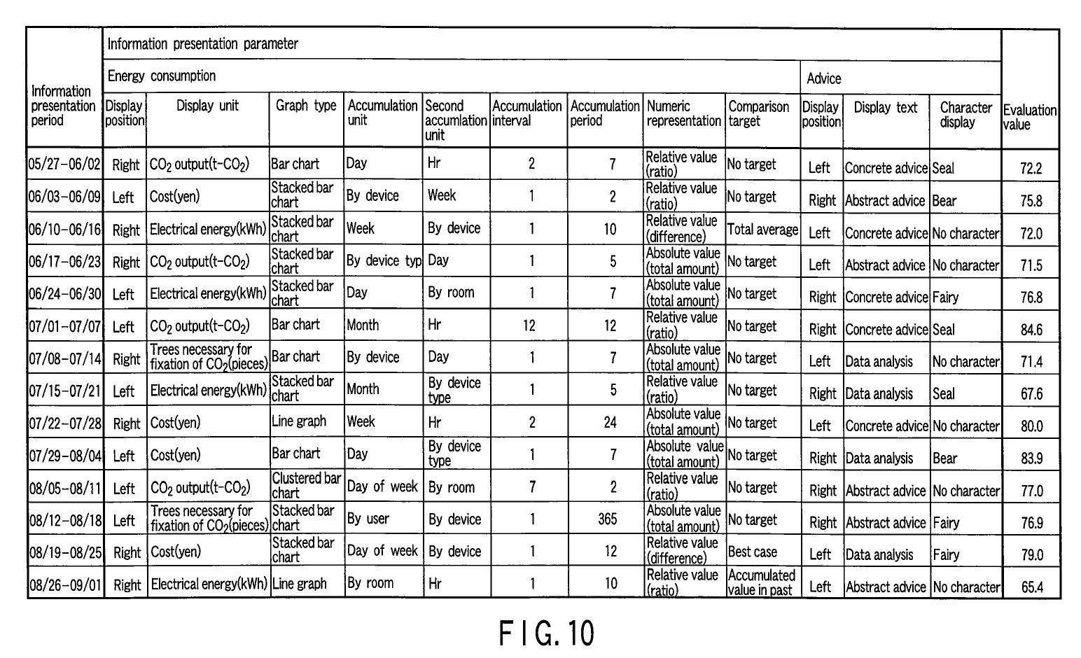

The evaluation result of the information presentation effect, which is obtained by the evaluation unit 3, is stored in the evaluation result storage unit 4 together with the information presentation period and the levels of parameters set for each display item shown in FIG. 10. In the example shown in FIG. 10, the evaluation value is the total energy consumption during the information presentation period.

Referring back to FIG. 2, in step S4, the parameter updating unit 6 determines, based on the evaluation result stored in the evaluation result storage unit 4, the level of parameters to be used for information presentation during the next information presentation period. When energy consumption is given as the evaluation value, as described above, the levels of the information presentation parameters are determined such that the energy consumption becomes smaller, and the information presentation parameters stored in the parameter storage unit 5 are updated to the new determined levels.

The level of each parameter is assigned a selection probability. A high selection probability is assigned as the degree of capability of decreasing the energy consumption rises. For example, when determining, as the level to be used during the next information presentation period, the level of the parameter “display unit” which has four levels “electrical energy”, “cost”, “CO₂ output”, and “trees necessary for fixation of CO₂”, the parameter updating unit 6 selects one level for each parameter based on the selection probability assigned to each level. For example, the parameter updating unit 6 selects the level having the highest selection probability for each parameter. During a training period in which the selection probability of each level of each parameter is not accurately defined, the level of each parameter may be selected at random.

The selection probability of each level of each parameter is stored in the parameter storage unit 5.

Using the levels determined and updated in step S4, information presentation is performed in step S2 in the same way as described above. In step S3, the evaluation value is calculated from the measurement result measured during the information presentation period, and the effect of information presentation during the information presentation period is evaluated using the evaluation value.

In step S4, in accordance with the increase/decrease (the evaluated information presentation effect) in the evaluation value (e.g., energy consumption here), the parameter updating unit 6 corrects or updates the selection probability of each level of each parameter stored in the parameter storage unit 5. The selection probabilities are corrected or updated for each information presentation period, thereby assigning a more accurate selection probability to each level. This makes it possible to easily select a level that has been displayed at the time of reduction of energy consumption.

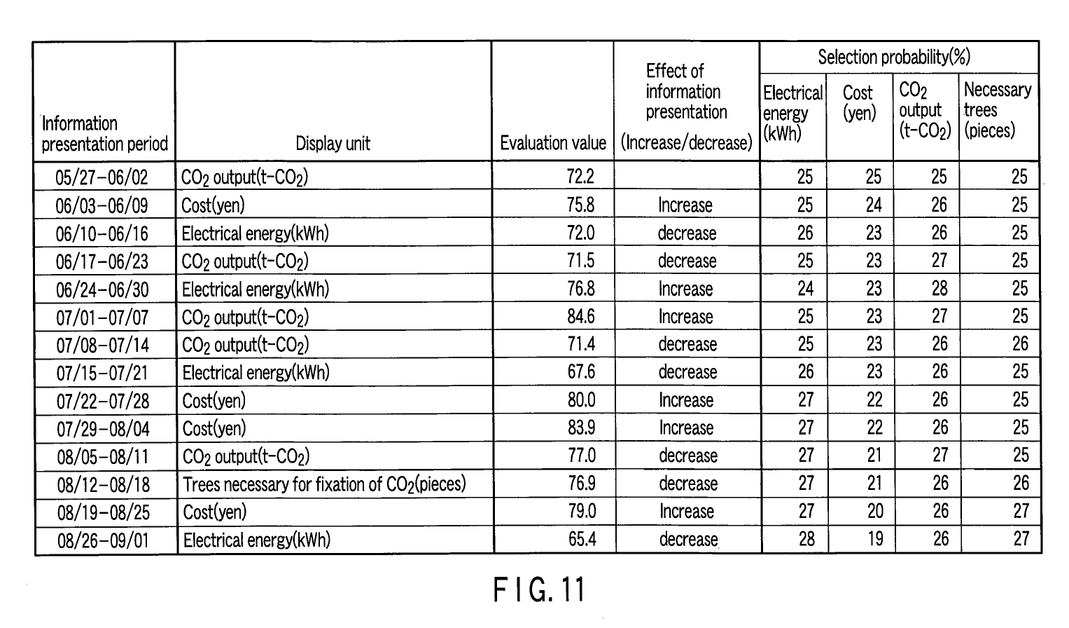

The selection probability correcting (updating) method in step S4 will be described in detail with reference to FIG. 11. A method will be described here in which the level of a parameter is changed to another level (in this case, without changing the levels of the remaining parameters), thereby assigning a selection probability to each level of the parameter.

Assume that when the level “CO₂ output” is selected for the parameter “display unit” during the “information presentation period” of “05/27-06/02”, the “evaluation value” is “72.2” kWh, and the selection probability “25%” is assigned as the initial value of each of the levels “electrical energy”, “cost”, “CO₂ output”, and “trees necessary for fixation of CO₂”.

If, based on the selection probability of each level, the level “cost” is selected as the value of the parameter “display unit” during the “information presentation period” of “06/03-06/09”, and the “evaluation value” is “75.8” kWh. Since the “evaluation value” “increases” as compared to the “information presentation period” of “05/27-06/02”, the selection probability of the level “CO₂ output” of the parameter “display unit” is raised, and the selection probability of the level “cost” is lowered. That is, if the evaluation value during the current information presentation period is larger than during the preceding (e.g., immediately preceding) information presentation period, the selection probability of the level used during the current information presentation period is lowered (by a predetermined value). Conversely, the selection probability of the level used during the preceding information presentation period is raised by the same value.

On the other hand, if the evaluation value during the current information presentation period is smaller than during the preceding (e.g., immediately preceding) information presentation period, an operation the reverse to that when the evaluation value has increased is performed. More specifically, the selection probability of the level used during the current information presentation period is raised (by a predetermined value). Conversely, the selection probability of the level used during the preceding information presentation period is lowered by the same value.

The above-described operation (i.e., the information presentation period) is repeated several times to correct the selection probability of each level (choice) of the parameter (e.g., “display unit” in this case) so that a higher selection probability is assigned to a level which has contributed to a decrease in the energy consumption upon actual information presentation. A level having a higher selection probability has a larger effect of decreasing the energy consumption of the user. For this reason, the parameter is readily selected.

It is also possible to obtain, for each display item, a parameter level (value) for decreasing the evaluation value (e.g., total energy consumption) using a method such as quantification theory II.

For example, the combination of levels of parameters “display unit”, “graph type”, “accumulation unit”, “second accumulation unit”, and “numeric representation” of the display item “energy consumption”, and the evaluation result of information presentation effect representing whether the evaluation value (e.g., total energy consumption) during the information presentation period in which information presentation has been done using the combination has become larger or smaller than that during the immediately preceding information presentation period are extracted from the evaluation result shown in FIG. 10, which is stored in the evaluation result storage unit 4. Analysis is performed using the level of each information presentation parameter used during each information presentation period as a predictor variable and an increase/decrease in the evaluation value as a response variable. A selection probability is determined based on the score in each of the categories “increase” and “decrease” obtained for each level of each parameter. That is, a higher selection probability is determined for a level having a higher score in the “decrease” category.

A method such as a genetic algorithm may be used for optimization in place of the above-described statistical analysis method such as quantification theory II.

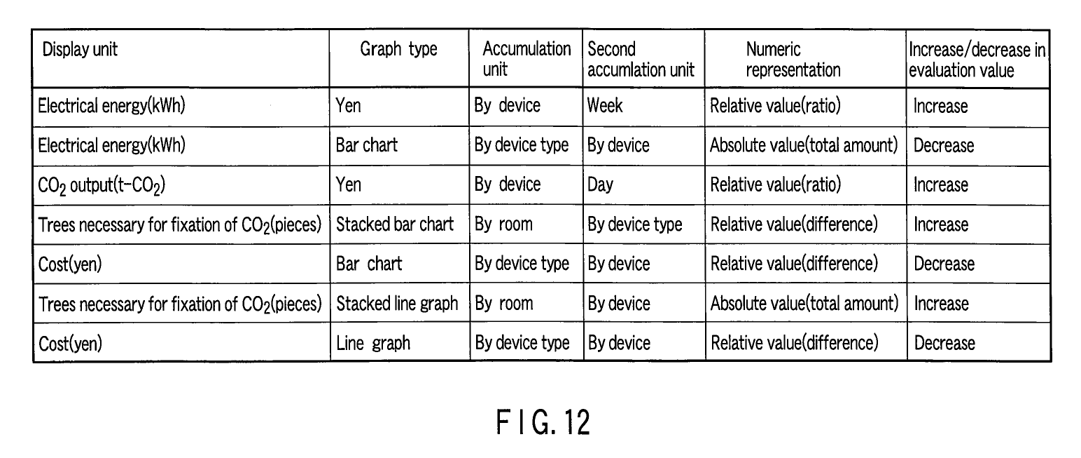

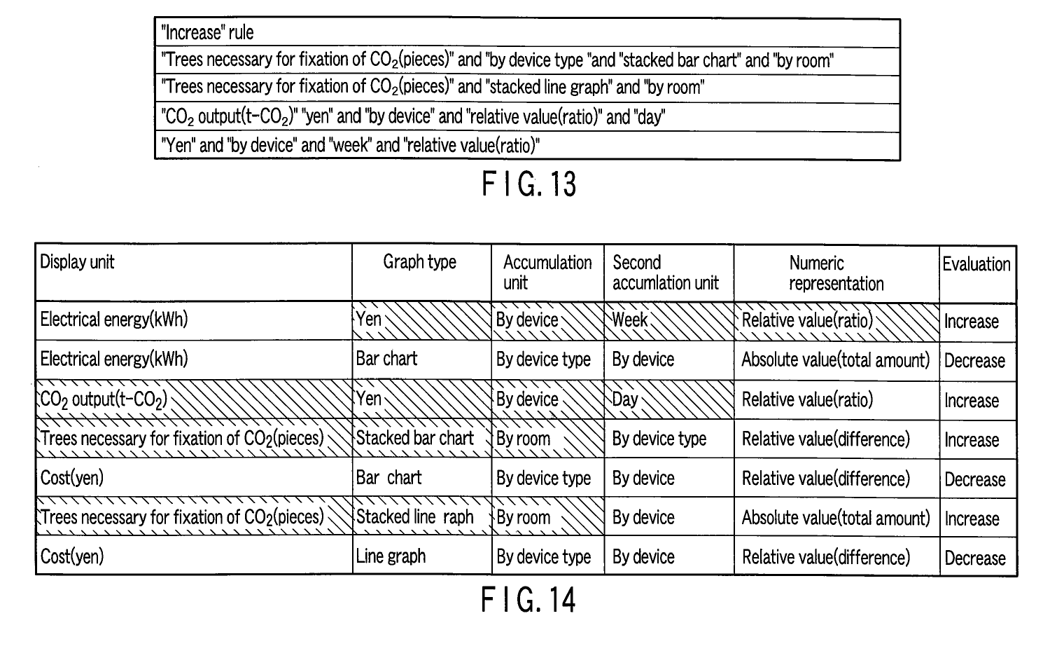

Alternatively, a rough set theory is applied to the information shown in FIG. 12 to extract conditions (a combination of levels of parameters) for increasing the energy consumption, as shown in FIG. 13. Then, it may be determined to change the levels corresponding to the extracted condition to other levels for decreasing the energy consumption, or the user may be notified of it. For example, when conditions as shown in FIG. 13 are extracted from the information in FIG. 12, the parameter updating unit 6 determines to change the levels (levels for increasing the energy consumption) indicated by the hatched cells in FIG. 14 to other levels or presents the details (the levels to be changed, which are indicated by the hatched cells) shown in FIG. 14 to the user.

As described above, in step S4, based on the evaluation result of the information presentation effect during the information presentation period (i.e., the effect of the values (levels) of the parameters used for information presentation during the information presentation period), which is obtained in step S3, the parameter updating unit 6 updates the selection probability of each level of each parameter. Additionally, the parameter updating unit 6 determines, based on the (e.g., updated) selection probability of each level, the levels of the information presentation parameters to be used during the next information presentation period. At this time, a level having a high selection probability is preferably selected. The process returns to step S2. In step S2, information presentation is done in accordance with the new information presentation parameters determined in step S4. When the procedures in steps S2 to S4 are repeated, it is possible to perform information presentation suitable for each occupant to implement energy consumption reduction.

As described above, according to the embodiment, the display method including the presentation details, expression, and display unit of information to be presented is set by parameter values, and the information is presented to the occupant in accordance with the set parameter values during a period designated in advance (information presentation period). The measurement result of an environmental load emission such as energy consumption which is emitted from the living space during the period is evaluated. Then, the selection probability of each parameter is, e.g., corrected to implement effective information presentation to prompt the occupant to adopt behavior significant for environmental load reduction. This operation is repeated to optimize the values of parameters so that information presentation suitable for each occupant can be done to prompt him/her to adopt behavior significant for environmental load reduction. It is consequently possible to reduce the environmental load imposed by a user's living space.

The method of the present invention (FIG. 2) described in the embodiment of the present invention can be stored in a recording medium such as a magnetic disk (flexible disk or hard disk), an optical disk (CD-ROM or DVD), or a semiconductor memory and distributed as a program to be executed by a computer.

According to the above embodiments, an environmental load caused by lifestyle can be reduced by presenting optimum information in a optimum manner to an occupant as needed.

What is claimed is:

1. A behavior improvement support apparatus for presenting information to prompt reduction of environmental load imposed by a user's living space, comprising:
a parameter memory to store, in regard to a plurality of parameters each having a plurality of values for specifying presentation methods of the information, one of the values of each parameter;
an information presentation unit configured to present the information during a given period of time, based on the one of the values of each parameter stored in the parameter memory;
a measurement unit configured to measure the amount of emission of the environmental load imposed by the living space during the period of time;
an evaluation unit configured to evaluate, based on the amount of emission of the environmental load during the period of time, an effect of the one of the values of each parameter used when the information is presented; and
a parameter updating unit configured to update, based on an evaluation result of the evaluation unit, the one of the values of at least one of the parameters stored in the parameter memory;
wherein the information presentation unit presents the information during the next period of time based on the value of each parameter which is stored in the parameter memory after update.

2. The apparatus according to claim 1, wherein the parameter updating unit update the one of the values of the one of the parameters stored in the parameter memory to another value of the one of the parameters.

3. The apparatus according to claim 1, wherein, to each of the values of each parameter, a selection probability representing a degree of capability of reducing the environmental load is assigned,
the evaluation unit compares the amount of emission of the environmental load or the average amount of emission per day of the environmental load during the period of time with that during another preceding period of time, and updates the selection probability of each value of each parameter based on a comparison result, and
the parameter updating unit update, based on the selection probability of each value, the one of the values of the one of the parameters stored in the parameter memory to another value.

4. The apparatus according to claim 3, wherein the evaluation unit
compares the amount of emission of the environmental load or the average amount of emission per day of the environmental load during the period of time with that during the another preceding period of time, and
increases, if the amount of emission of the environmental load or the average amount of emission per day of the environmental load during the period of time is smaller than that during the another preceding period of time, the selection probability of the value of the parameter used during the period of time by a predetermined value and decreases the selection probability of the value of the parameter used during the another preceding period of time by the predetermined value.

5. The apparatus according to claim 4, wherein if the amount of emission of the environmental load during the period of time is larger than that during the another preceding period of time, the evaluation unit decreases the selection probability of the value of the parameter used during the period of time by a predetermined value, and increases the selection probability of the value of the parameter used during the another preceding period of time by the predetermined value.

6. The apparatus according to claim 1, wherein, to each of the values of each parameter, a selection probability representing a degree of capability of reducing the environmental load is assigned, and
further comprising
a measured data memory to store the amount of emission of the environmental load measured by the measurement unit during each period of time of a plurality of periods of time, the values of the parameters used during one of the periods of time being different from that used during any one of the other periods of time, and
wherein the evaluation unit updates the selection probability of each value of each parameter based on the amount of emission of the environmental load during each period of time, which is stored in the measured data memory.

7. A behavior improvement support method in a behavior improvement support apparatus for presenting information to prompt reduction of environmental load imposed by a user's living space, comprising:
storing, in a parameter memory, in regard to a plurality of parameters each having a plurality of values for specifying presentation methods of the information, one of the values of each parameter;
presenting the information during a given period of time, based on the one of the values of each parameter stores in the parameter memory;
measuring the amount of emission of the environmental load imposed by the living space during the period of time;
evaluating, based on the amount of emission of the environmental load during the period of time, an effect of the one of the values of each parameter used when the information is presented;
updating, based on an evaluation result, the one of the values of at least one of the parameters stored in the parameter memory;
presenting the information during the next period of time based on the value of each parameter which is stored in the parameter memory after update.

8. The method according to claim 7, wherein, to each of the values of each parameter, a selection probability representing a degree of capability of reducing the environmental load is assigned, evaluating includes comparing the amount of emission of the environmental load or the average amount of emission per day of the environmental load during the period of time with that during another preceding period of time, and updating the selection probability of each value of each parameter based on a comparison result, and
updating updates, based on the selection probability of each value, the one of the values of the one of the parameters stored in the parameter memory to another value.

9. The method according to claim 8, wherein updating the selection probability of each value of each parameter increases, if the amount of emission of the environmental load or the average amount of emission per day of the environmental load during the period of time is smaller than that during the another preceding period of time, the selection probability of the value of the parameter used during the period of time by a predetermined value, and decreases the selection probability of the value of the parameter used during the another preceding period of time by the predetermined value.

10. The method according to claim 9, wherein updating the selection probability of each value of each parameter decreases, if the amount of emission of the environmental load during the period of time is larger than that during the another preceding period of time, the selection probability of the value of the parameter used during the period of time by a predetermined value, and increases the selection probability of the value of the parameter used during the another preceding period of time by the predetermined value.
